(19) United States
(12) Patent Application Publication
(10) Pub. No.: US 2011/0145128 A1
(43) Pub. Date: Jun. 16, 2011

(54) System and Method for Auctioning Environmental Commodities

(75) Inventors: Naeem Hukkawala, Brooklyn, NY (US); Kapil Mohindra, New York, NY (US); Kent Gibson, South Orange, NJ (US); David Bredesen, New York, NY (US); Eftichi Goumas, New York, NY (US); Karin Wichman, Darien, CT (US)

(73) Assignee: Skystream Markets, Inc., New York, NY (US)

(21) Appl. No.: 12/970,852

(22) Filed: Dec. 16, 2010

Related U.S. Application Data
(60) Provisional application No. 61/286,891, filed on Dec. 16, 2009.

(51) Int. Cl. G06Q 40/00

(52) U.S. Cl. 705/37

(57) ABSTRACT

An institutionally-focused, neutral auction platform is provided that may be utilized for both the primary and secondary trading of environmental commodities and instruments. The auction platform may perform an on-boarding process for auction participants. Thereafter, the auction platform initiates an auction event, in response to a request by an auctioner, based on an identified block of environmental commodities. The auction platform may also receive an indication of financial security from one or more of the auction participants. A winning bidder may then be selected based on auctioner-defined parameters. In certain embodiments, the auction platform may also perform a settlement function for the auctioner and winning bidder relating to the delivery of, and payment for, the identified block of environmental commodities. Various other services and processes may also be provided by the auction platform.

### CROSS REFERENCE TO RELATED APPLICATION

This application claims the benefit of U.S. Provisional Patent Application No. 61/286,891, filed Dec. 16, 2009.

### FIELD OF THE INVENTION

The present invention relates to auctioning of environmental commodities, and more particularly to providing an institutionally-focused system, method and architecture by which environmental commodities may be auctioned on a neutral platform such that buyers are provided with accessible liquidity and sellers are provided with competitive bid or offer prices.

### BACKGROUND

Broadly speaking, an auction is a process of buying and selling goods or services whereby a seller first offers such goods or services up for bid, accepts bids from potential buyers, and then sells the goods or services to the highest bidder. And while auctions themselves have been recorded as early as 500 B.C., it is only in the last decade that a number of environmental commodities have been created. Such environmental commodities include Renewable Energy Certificates (RECs), Carbon Offsets, Carbon Allowances and so-called white certificates (e.g., Energy Efficiency Credits).

While there have been some attempts to implement auctions for environmental commodities, such approaches are limited in several respects. In addition to being very rudimentary, known methodologies for environmental commodity auctioning suffer from numerous drawbacks. For example, current platforms are not institutionally focused, are exclusively limited to spot auctions, and provide no mechanism for trading relationships to be established, and do not manage post-trade processing and reporting. Additionally, there is no current solution which adequately addresses the credit risk issue. Thus, there is a need for an improved system and method of auctioning environmental commodities which overcomes one or more of the aforementioned drawbacks.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A depicts an auction platform architecture configured to implement one or more aspects of the invention;

FIG. 1B illustrates a credit & financial security module of the architecture depicted in FIG. 1A, configured with accordance with the principles of the invention;

FIG. 2 depicts a system in a network environment configured to implementing one or more aspects of the invention;

FIGS. 3A-3C depict exemplary graphical user interfaces relating to certain aspects of the auction monitoring functionality of the invention;

FIG. 4A illustrates an example of the auction module depicted in FIG. 1A configured to implement a single-term unilateral auction;

FIGS. 4B-4C depict exemplary graphical user interfaces (GUIs) relating to the auction module of FIG. 4A;

FIG. 5A illustrates an example of an auction module of the architecture depicted in FIG. 1A configured to implement a two round multi-term unilateral auction;

FIG. 5B illustrates another example of an auction module of the architecture depicted in FIG. 1A configured to implement a single round multi-term unilateral auction;

FIGS. 5C-5H depict exemplary GUIs relating to the auction modules of FIGS. 5A and 5B;

FIG. 6A illustrates another embodiment of an auction module of the architecture depicted in FIG. 1A configured to implement a multilateral auction;

FIGS. 6B-6C depict exemplary GUIs relating to the auction module of in FIG. 6A;

FIG. 7 illustrates a post auction module of the architecture depicted in FIG. 1A, configured with accordance with the principles of the invention; and

FIGS. 8A-8D depict various embodiments of post auction modules of the architecture depicted in FIG. 1A, configured with accordance with the principles of the invention.

### SUMMARY OF THE INVENTION

Disclosed and claimed herein is a method, server and computer program product for auctioning environmental commodities on a neutral trading platform in an online environment. In certain embodiments, the neutral trading platform is implemented using an auction platform server coupled to a network. One method of carrying out the invention is to execute, by the auction platform server, an on-boarding process for the auction participants, which include an auctioner. The auction participants may utilize client-side devices to access the auction platform server over the network. In certain embodiments the on-boarding process includes having the trading platform enter into one of a subscription agreement, brokerage agreement and auction-specific agreement with each of the auction participants. The method may further include initiating, by the auction platform server and in response to a request by the auctioner, an auction event based on an identified block of environmental commodities. Thereafter, the auction platform server may receive an indication of financial security from one or more of the auction participants. The method further includes receiving, by the auction platform server over the network, various bids for the identified block of environmental commodities from the auction participants. Once the bids have been validated against a predetermined set of criteria, a winning bidder may be selected using one of an automated fills methodology and auctioner-defined parameters. In certain embodiments, the auction platform may also perform a settlement function for delivery of, and payment for, the identified block of environmental commodities.

Other aspects, features, and techniques of the invention will be apparent to one skilled in the relevant art in view of the following description of the exemplary embodiments of the invention.

### DETAILED DESCRIPTION OF EXEMPLARY EMBODIMENTS

### Disclosure Overview

One aspect of the present disclosure relates to providing an auction platform that may be utilized for both the primary and secondary trading of environmental commodities and instruments, including RECs, Carbon Allowances, Carbon Offsets, and Energy Efficiency Credit, although it should be appreciated that any other type of environmental commodities/instrument may be similarly auctioned in accordance with the principles of the invention disclosed herein.

In one embodiment, the auction platform may provide a unique service to the environmental commodities market by offering a neutral platform for both buyers and sellers to achieve competitive transactions. More specifically, the invention may provide accessible liquidity for buyers, while also providing competitive sealed bid prices for sellers.

Another aspect of the invention is to implement the auction platform in terms of a “multi-term auction,” which provides the ability to auction a forward stream on both a firm and/or contingent basis. Alternatively, the invention may be implemented as a “multilateral auction,” whereby two rounds of processing are used to establish a market clearing price and a subsequent trading period.

Still another aspect is to provide complete credit/financial security that supports both prior established trading relationships (based on terms of written agreement), as well as ad hoc trading. Additionally, the principles of the invention envision a structured data reporting mechanism and interface for individual auction events that may be used for valuation and analytics.

Additional aspects of the invention, which will be described in more detail below, include automated trade confirmation and processing, operational processes for the fulfillment of financial reporting requirements and credit monitoring, and collateral and settlement reporting. Additionally, the auction platform disclosed and claimed herein may further provide for collateral management, including a standardized process for collateral adjustments and financial security allocation for multiple partners in multi-term auctions.

It should be appreciated that the auction platform of the present invention may be implemented in a client-server type architecture in which the individual users access one or more remote servers over a network using a client application that executes on a client-side computer. The auction platform itself may then reside on one or more remote servers that are accessible to the client-side computer. Alternatively, the client-side computers may access the auction platform server using a browser-type application.

As used herein, the term “financial security” refers to collateral posted to support participation in an auction. The term “holding account” refers to an account used to house instruments to be auctioned. The term “vintage” means the date of issuance for a particular environmental commodity (e.g., REC). Different regulatory bodies have different procedures and periods (i.e., vintages) for issuing environmental commodities. While the general term “auction” refers to an auction event in which there are multiple buyers and a single seller, a “reverse auction” refers to an auction event in which the roles of buyers and sellers are reversed such that there are multiple sellers, but only a single buyer. Additionally, the term “auctioner” means a party who initiates an auction, which is the seller in the case an auction, or is the buyer in the case of a reverse auction. It should be appreciated that the principles of the invention, as disclosed herein, may be equally applicable to auctions and reverse auctions.

While the following disclosure refers principally to the REC market, this is intended to be an exemplary embodiment only and may equally be applied to any other environmental commodities/instrument or hybrid thereof. Similarly, while many of the exemplary embodiments which follow are in terms of a traditional auction having a single seller and multiple buyers, it should be appreciated that each and everyone of those exemplary embodiments may be equally implemented as a reverse auction.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that may be performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the processor-executable code segments to perform the necessary tasks. The code segments can be stored in a “processor readable medium,” which includes any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

### Exemplary Embodiments of the Invention

Prior to being able to avail oneself of the auction platform disclosed herein, it should be appreciated that one or more prerequisites may need to be satisfied. By way of example, in certain embodiments it may be necessary for each clients (i.e., buyer or seller) to complete an “on-boarding”process prior to participating in any auction event. The on-boarding process may include having the client enter into a subscription, brokerage and/or auction-specific registration agreement which covers the client's responsibilities, liabilities, indemnity, software licensing rights and the like. Thus, auction participants are provided a standardized contractual process by which to establish the necessary contractual relationships with both the platform and potential counterparties, prior to actually commencing an auction or other transaction.

The on-boarding process may be tailored for a specific auction or on a per-client basis. In particular, the platform may generate streamlined contracts for use between counterparties as a “default” agreement based on, for example, the parties involved. Additionally, the seller may tailor otherwise standard contract terms before marketing the agreement. In certain cases where the seller does not have extensive experience, advisory or consulting contract services may be provided to the seller as part of the on-boarding process.

Once the seller selects or finalizes the auction agreement, the seller may market the agreement either “as is” or open to buyer negotiation, whereby the auction platform may facilitate any such negotiation process. Finalized agreement terms may then be incorporated into the platform's operations systems in order to provide post-trade services in accordance therewith.

The on-boarding process may also require the client to provide some initial baseline information, such as the legal name, address, contact information and other data corresponding to the actual legal entity that will be engaging in the trading activity. During this process, the client-specific settlement instructions (e.g., instructions for confirmations, return of financial security, delivery of RECs, etc.) may also be provided and stored as part of the client's profile.

Other information that the client may provide includes a list of authorized users with contact details and authorization level, and potentially a list of approved counterparties with whom the particular client has executed credit facilities, e.g. an ISDA Master Agreement with an executed US Emissions Allowance Transaction Annex, or a Master Renewable Energy Certificate Purchase and Sale Agreement. Any such agreement will be generically referred to herein as a “trading agreement.” Included in the list of counterparties may be associated trading limits and specified products which are allowed under such trading agreements.

The client on-boarding process may similarly include such steps as installing a desktop software auction component on the client's desktop, performance of connectivity testing and client training on the auction platform.

It should of course be appreciated that the client on-boarding process need not include each of the steps described above, or may include additional steps not identified above but otherwise readily known to be useful or necessary in establishing user access to a trading platform.

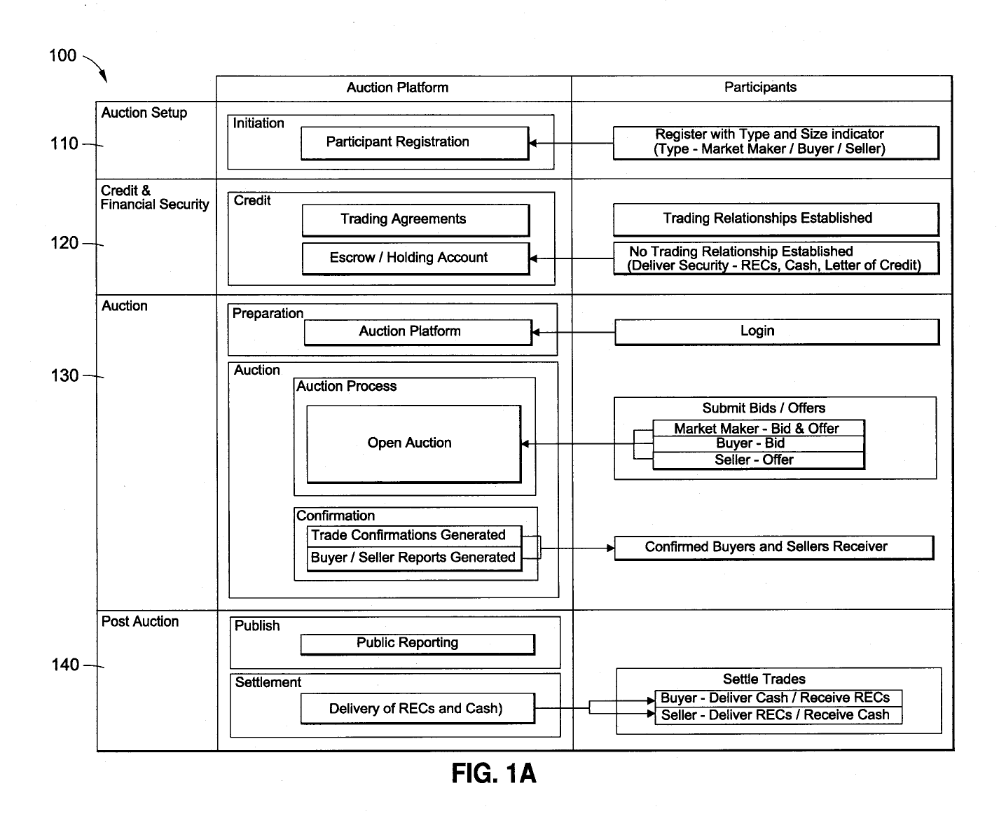

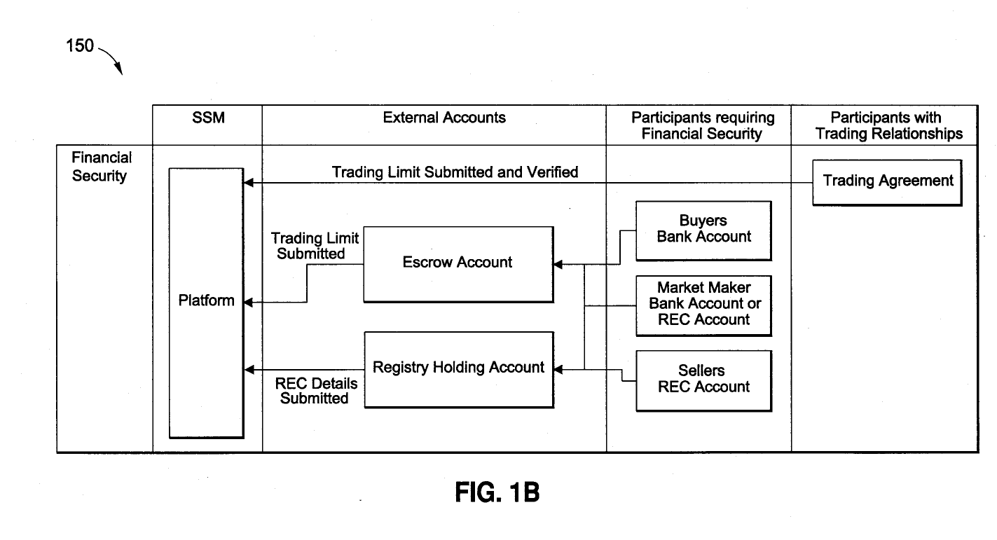

Once the on-boarding process is complete, a client may begin to engage in trading activities using the auction platform of the invention. To that end, FIG. 1A depicts one embodiment of the auction platform 100 of the invention, which is consistent with the various auction types envisioned and described herein. As shown, platform 100 includes an auction setup module 110, a credit & financial security module 120, and auction module 130 and a post auction module 140. As previously described, the platform 100 may be implemented using one or more networked-servers that are accessible by client-side computers executing a client application or via a browser-type interface.

With reference first to the auction setup module 110, an auction event may be initiated when a client identifies a specific block of RECs to buy or sell on either a single- or multi-term basis. Alternatively, an auction event may be run on a periodic basis (e.g., weekly, monthly, quarterly, etc.) depending on the instrument involved, compliance periods, etc.

Various parameters may be defined during auction setup as well. For example, the auction itself may be defined as a unilateral auction or a multilateral auction. While a unilateral auction is a single direction event (e.g., seller to buyer), a multilateral auction is a bi-directional event between participants that may act as buyers or sellers.

In the case of a unilateral auction, a seller may submit an auction request form which may include one or more of the following:
instrument to be auctioned (State, REC type, Tier of REC and Compliance price),
vintages to be auctioned,
quantity,
minimum quantity per bid, and
reserve price per vintage.

With respect to the quantity, the auction request may specify, in addition to the number of RECs to be sold, a minimum number of RECs per vintage. Additionally, some auctions may also limit the quantity to some predetermined percentage (e.g., 75%) of the projected production output per project, also known as the “firm” amount.

Continuing to refer to the auction setup module 110, auction participants may indicate their interest by responding to an alert or call from the auction platform/staff. In certain embodiments, this response may include the participant type (e.g., buyer, seller, or market maker), and the trading size. The auction setup module 110 may then review trading relationships to determine if there are any existing trading agreements. If so, then the auction trading limit referenced in the appropriate trading agreement will be used.

If on the other hand there is no existing trading agreement in place between the participants in question, the auction setup module 110 may then determine if the prospective participant has escrow account documentation on file. If so, a financial security submission form may be sent to the particular participant to complete prior to delivery of the financial security. On the other hand, if the prospective participant has not established an escrow account, the auction setup module 110 may facilitate the execution of a tri-party escrow agreement with an agent instead.

Finally, it should be appreciated that the auction setup module 110 may monitor the number of participants that have registered to participate since a minimum number of participants may be required for an auction to run (e.g., 3 buyers and 3 Sellers).

With reference now to FIG. 1B, depicted in one embodiment of the credit & financial security module 120 of FIG. 1A. In particular, financial security module 150 of FIG. 1B can accommodate three types of credit relationships—trading relationships based on existing trading agreements, or financial security posted to an escrow/holding account for a specific auction event, or relationships in which financial security requirement has been waived.

In the case of an escrow/holding account a predetermined number of business days prior to the auction event (e.g., 2 days) the seller may be required by the financial security module 150 to deliver either the RECs to be auctioned to a designated holding account, or collateral to an escrow account, while the buyer may be required to deliver its financial security in the form of cash or a Letter of Credit to the designated escrow account. Similarly, market makers may be required to deliver either cash or Letter of Credit to the designated escrow account or RECs to the designated holding account. While in this example, the auctioner is the seller, it should similarly be appreciated that the auctioner may be a buyer, i.e., in the context of a reverse auction.

In general, the pre-trade standardized financial security process may comprise having the parties post financial security prior to auction (e.g., cash, Letter of Credit, guarantee, insurance, etc.). The amount of the financial security may similarly be standardized, e.g., 10% of notional amount (reserve price) for seller, 10% of trading limit for buyer, or any other fixed percentage. The posted financial security may then be held in an escrow account by a third party bank pursuant to an escrow agreement between the bank and the party, with the auction platform serving as the trustee/administrator.

Thereafter, the financial security module 150 may review the designated holding or escrow account to ensure that all required RECs, cash or Letters of Credit have been received from the prospective participants. The financial security module 150 may then post details of deliveries to the system for settlement and reporting, and set any auction limits based on the financial security provided or the preexisting trading relationship (i.e., agreement terms). In certain embodiments, the RECs may be afforded an equivalent value calculated by multiplying the number of RECs at the most recent market price times some predetermined percentage less than 100% (e.g., multiply by 0.8). Additionally, this reduced valuation may be applicable only in the case of multilateral auctions.

In addition to establishing the financial security prior to the auction event, participants may also be required to login to the platform and access an appropriate auction screen (e.g., via a client-side browser-type application). The auction platform (e.g., platform 100) may track users signed in versus those registered for an auction through the auction setup module 110. In this fashion, if registered participants have not logged into the specified auction in time, they may be contacted via phone, email or text to alert them to the pending auction. Those unable to log onto the platform may be offered other alternatives for participating in the auction (e.g., phone participation).

During the life of the transaction/auction, the platform (e.g., platform 100) may also provide a financial reporting service for buyers and sellers. Such financial reporting may be based on various required public company disclosures (e.g., 10K's, 10Q's, etc.), as well as available private company financials (e.g., quarterly unaudited financials, annual audited financials, etc.). The financial reporting service may include forwarding such financial reports to counterparties. This service may be performed in accordance with a trading agreement, for example.

In addition to the aforementioned financial reporting service, one or more modules of the auction platform may further provide credit monitoring services to ensure compliance with credit assurance provisions, e.g., from a trading agreement. The credit monitoring service may be automated and may comprise monitoring applicable counterparties' credit ratings, and providing notice to clients upon predetermined credit changes (e.g., a downgrade) that might trigger or increase the risk of a default event. In the event of such a credit change, the auction platform may facilitate the process for posting additional collateral (credit assurance), as needed.

Still another service that may be provided by one or more modules of the auction platform (e.g., platform 100) relates to the collateral and settlement reporting aspect of the auction process. In particular, one of the auction platform modules, such as post-auction module 140, may provide clients with periodic (e.g., monthly, quarterly) collateral reports/financial security statements. Additionally, the auction platform may further facilitate the negotiation process if a collateral threshold is breached, or other security event occurs that requires client negotiation. The auction platform may act as trustee/administrator of any security escrow account that is involved in the collateral posting process.

With respect to post-trade collateral processing, auction “losers” may have their security returned through the auction platform. Security for the buyer(s) and seller(s) may also be adjusted to reflect trade notional and contract requirements.

Collateral processing services may be provided throughout the entire life of the trade, including return of collateral upon delivery of the auctioned commodity, and performing collateral adjustments as triggered by collateral threshold events, credit events, etc. The auction platform, as trustee/administrator, would instruct the applicable bank accordingly.

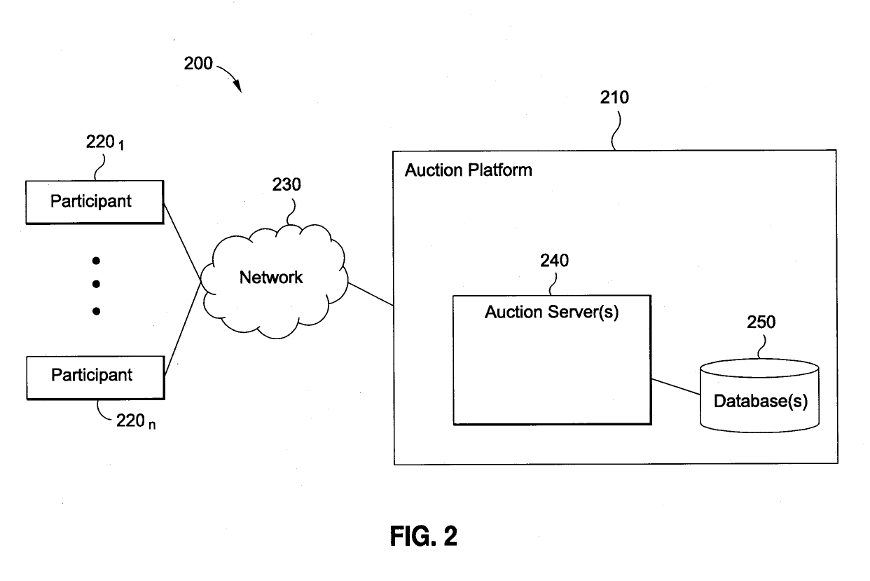

With reference now to FIG. 2, depicted is an exemplary system in which the present invention may be implemented in a client-server type architecture. Specifically, system 200 comprises the auction platform 210, which may be platform 100 of FIG. 1A, in communication with a plurality of individual auction participants 220₁-220ₙ over a network 230. As previously mentioned, it should be appreciated that each of the plurality of auction participants 220₁-220ₙ may connect to the platform 210 using a client application (or browser-type application) that executes on a client-side computer. The auction platform 210 may reside on one or more remote servers 240 that are accessible to the client-side computer over the network 230. The auction platform may further comprises one or more databases 250 for storing data necessary or useful for carrying out the various operations described herein with respect to the disclosed auction platform.

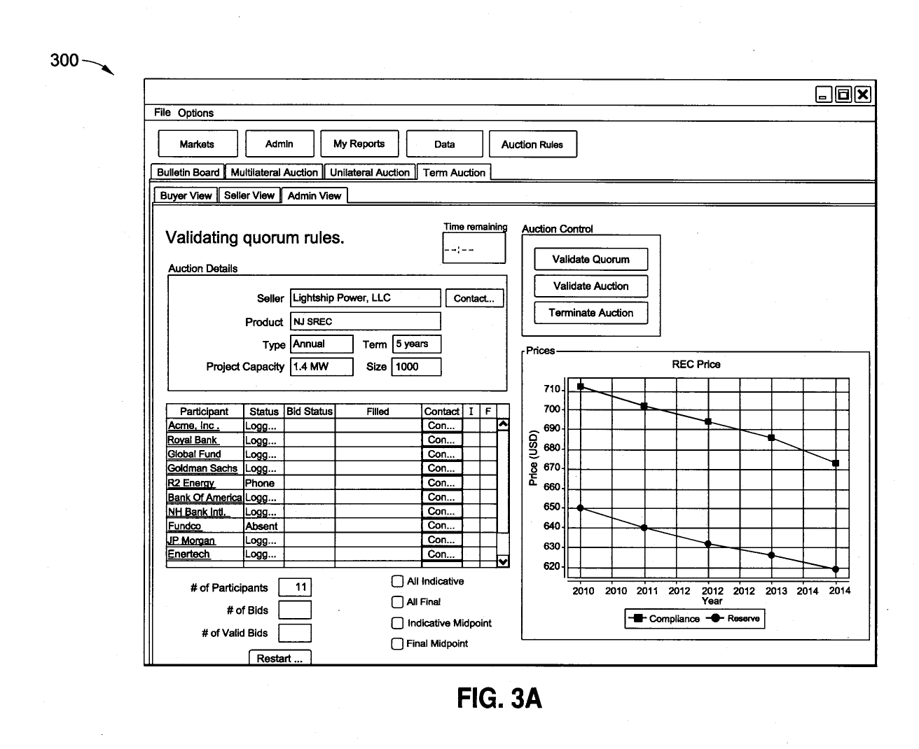

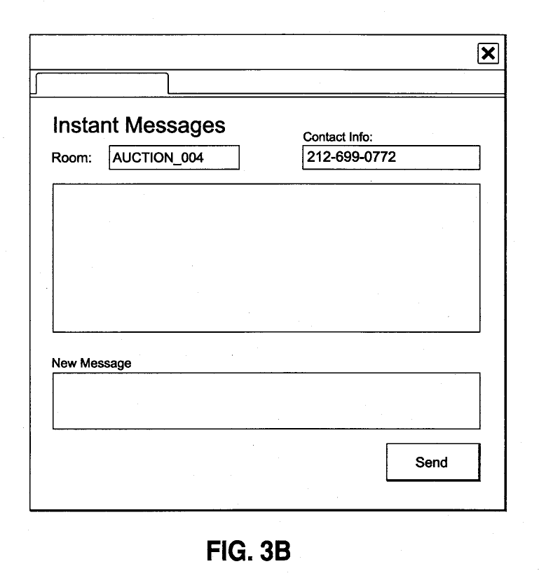

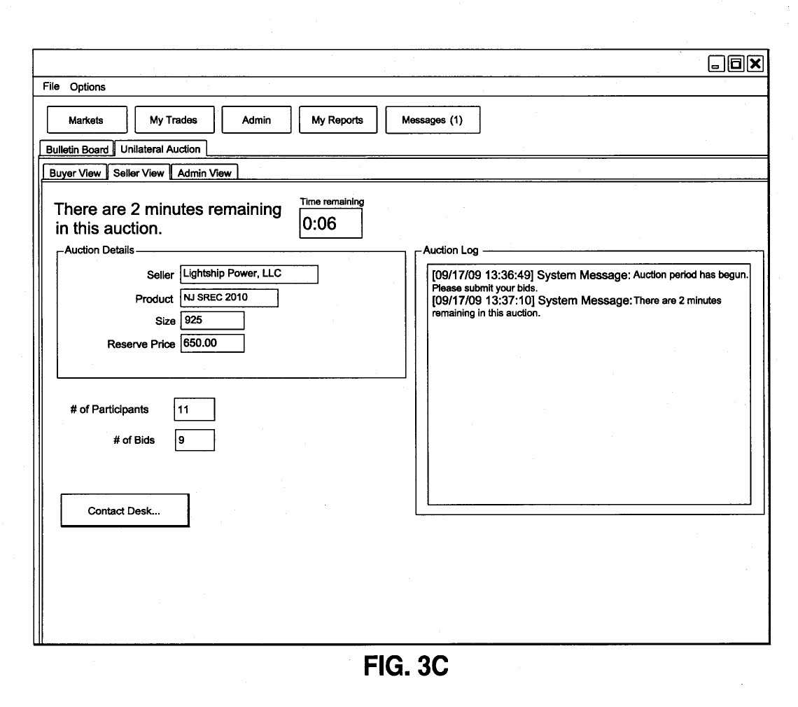

Referring now to FIG. 3A, depicted is one embodiment of a graphical user interface 300 that may be used by a dedicated support team responsible for running and supporting auction events. In this fashion, comprehensive monitoring of all activity during the entire auction process may be provided so as to ensure the validity and efficient operation of the auction processes, as well as provide support to buyers and sellers on a real-time basis.

Additionally, all clients and support staff may utilize a bi-directional instant messaging system for communications during auctions (see FIG. 3B). Participants may also view a screen with a log of all auction events as they occur (see FIG. 3C).

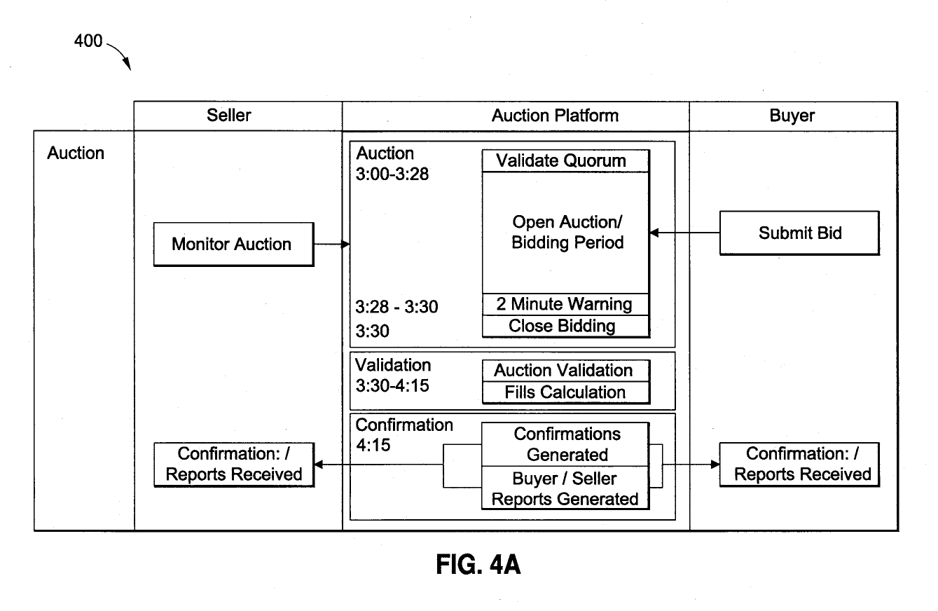

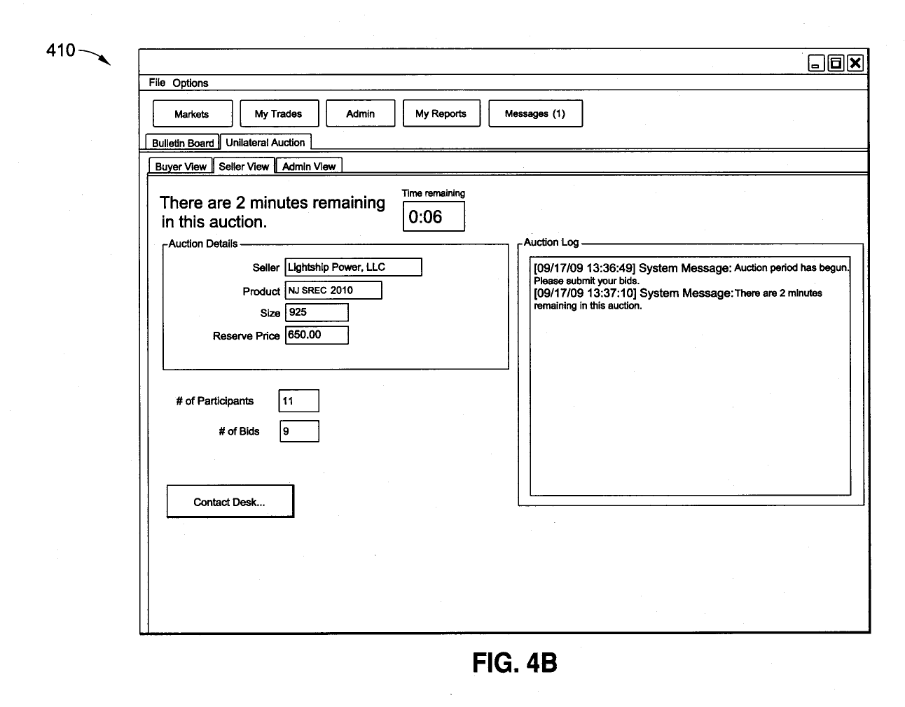

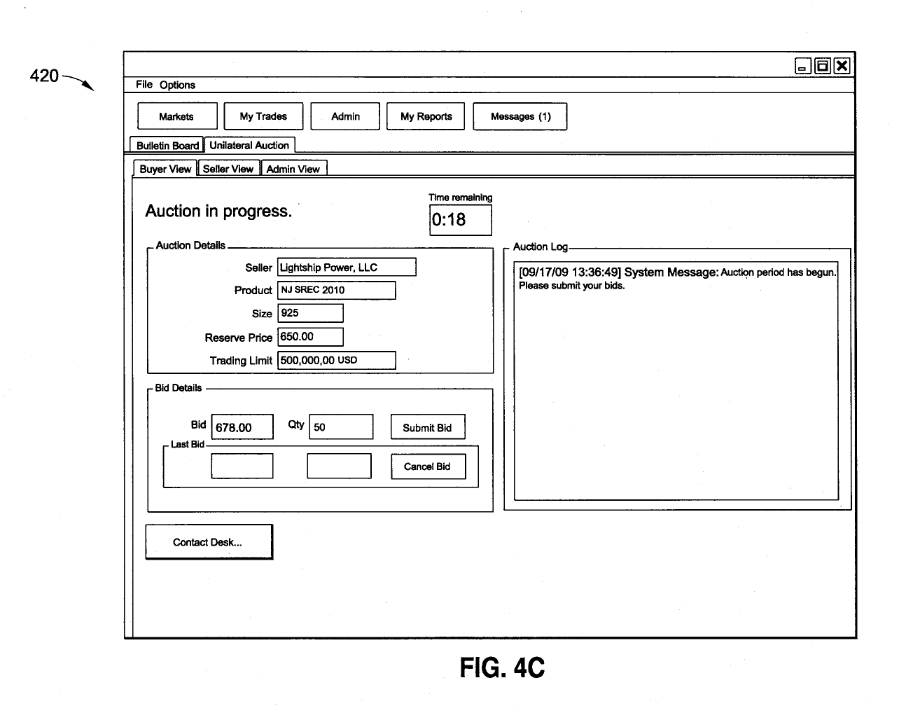

Referring now to FIG. 4A, depicted is one embodiment of the auction module 130 of FIG. 1A. In the embodiment of FIG. 4A, the auction module 400 is configured to implement a single-term unilateral auction of RECs (or any other environmental commodity).

In the case of a single-term unilateral auction, it may first be necessary to ensure that a quorum of bidders (e.g., 3) exists to begin a valid auction. In any event, once the auction starts the sellers may be provided with access to a screen, such as screen 410 of FIG. 4B, that will inform them of key events in the progress of an auction and other statistics while in progress.

Similarly, buyers may utilize a bidding screen, such as screen 420 of FIG. 4C, to submit and/or cancel bids. Bidding continues until the auction time expires. Participants may be given a warning prior to the close of bidding, followed by an alert once the auction is closed to further bidding.

Submitted bids may then be validated by the auction platform. This validation process may include ensuring that the quantity bid is limited to the total number of RECs to be auctioned in a single event and potentially subject to a minimum size as defined during auction setup. Additionally, the quantity bid may be limited to the notional amount of the quantity multiplied by the price submitted and compared to the trading limit established by external agreements or the financial security. Similarly, the price bid may be required to be greater than the reserve price, as indicated in auction setup, and may be no greater than the compliance price plus some predetermined percentage (e.g., 25%). This feature may serve as a form of protection for bidders' data entry error.

Upon auction validation, bids will be filled on a pro-rata basis subjected to a predetermined set of rules. For example, bids may be sorted in descending order by price and quantity with winners assigned to the bids with the highest price, then continuing down the list until the entire quantity of the auction is exhausted. If more than one bid exists at a winning price level, the bids at that price level may be filled as follows:
if the total quantity of the winning bids at a price are less than or equal to the total quantity remaining to be sold, all bids will be fully filled, or
if the total quantity of the winning bids at a price exceeds the total quantity remaining to be sold, a straight percentage calculation will be applied to the quantities of the bids versus the total quantity to be sold.

Each winning order may then be filled pro-rata similar to the percentages calculated. By way of example, assuming 4 bids and an auction quantity of 100, the bids may be filled as follows:

| | Price | Quantity | Percentage | Filled Amount |
|---|---|---|---|---|
| Bid 1 | 55 | 60 | 40.00% | 40 |
| Bid 2 | 55 | 50 | 33.33% | 33 |
| Bid 3 | 55 | 40 | 26.67% | 27 |
| Bid 4 | 45 | 10 | n/a | 0 |

Alternatively, the auction platform may support other auction methodologies, such as the following:
1. All or Nothing: Sealed bid auction where bidders will be required to submit bids for the entirety of quantity to be sold resulting in a single winning bid.
2. Rounds of Anonymous bidding: Simultaneous or consecutive sealed or open bid auctions for each round specified for a different vintage.
3. Second price auction: Sealed bid auction where winning bidder's pay the highest losing price.
4. Display Rank: Bidders will be shown their rank in the auction through the open bidding phase and will disappear during a time window, e.g. 2-minute window, prior to auction close.
5. Market Clearing Price: Sealed bid auction where bids are sorted in descending order by price and size, with the clearing price being set by the lowest price to be filled (see table below for example).

Auction Quantity 100

| | Price | Quantity | Filled Amount | Clearing Price |
|---|---|---|---|---|
| Bid 1 | 60 | 60 | 60 | 57 |
| Bid 2 | 57 | 50 | 40 | 57 |
| Bid 3 | 55 | 40 | | |
| Bid 4 | 45 | 10 | | |

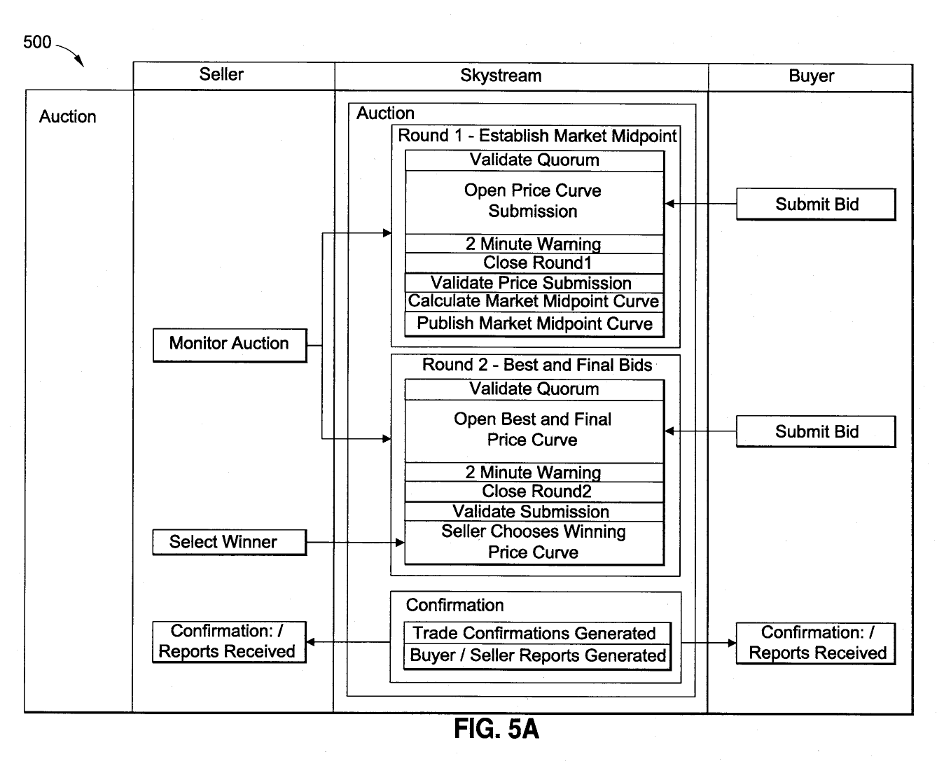

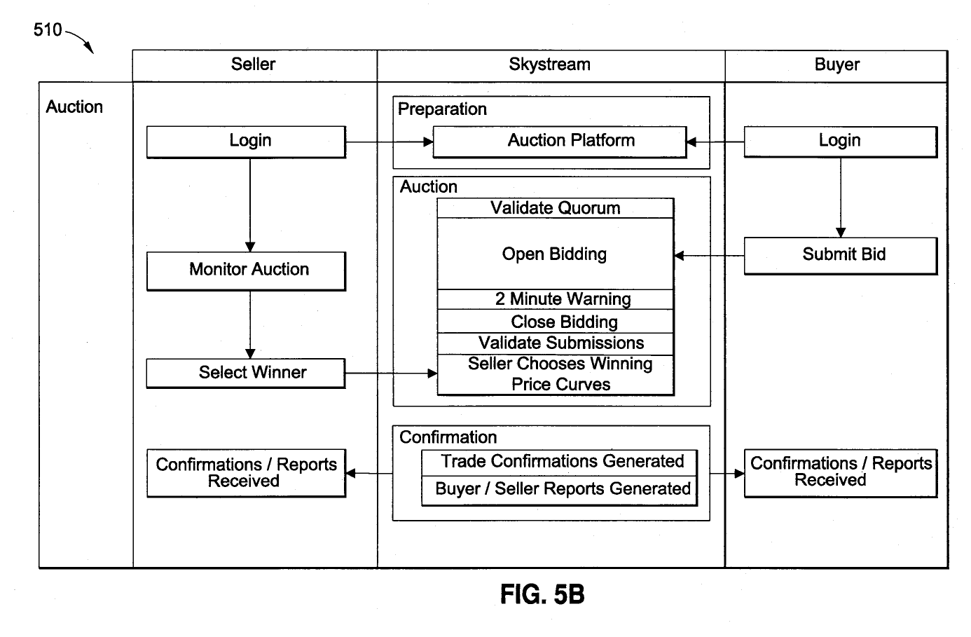

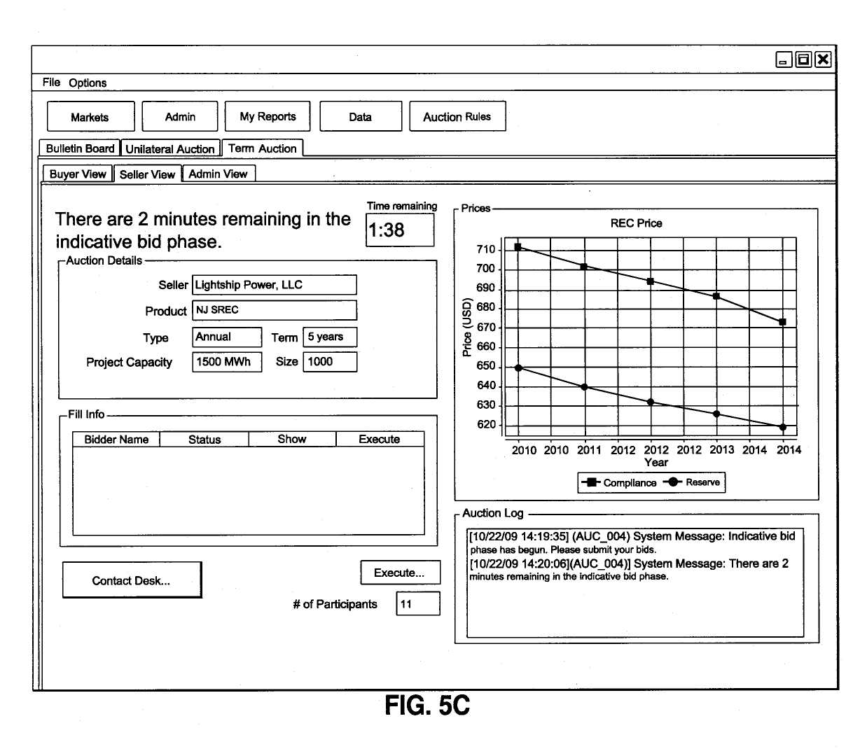

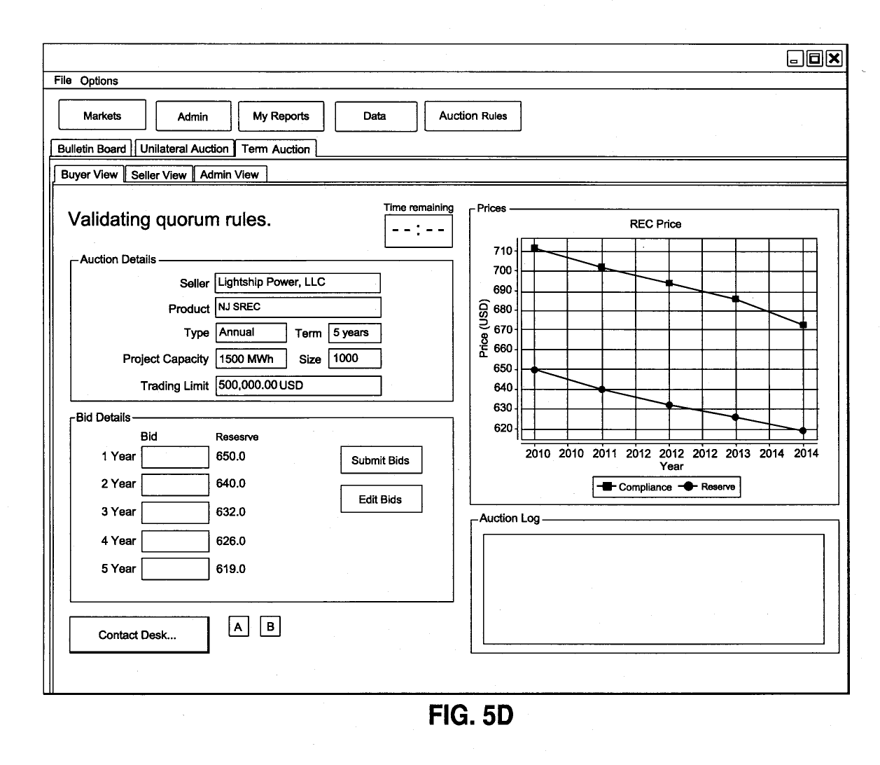

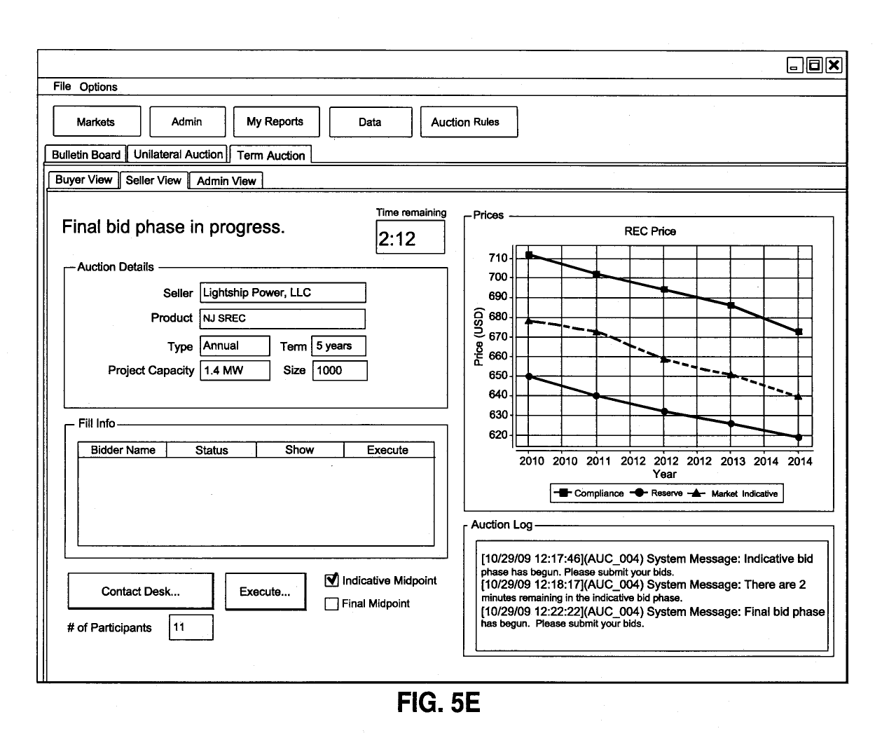

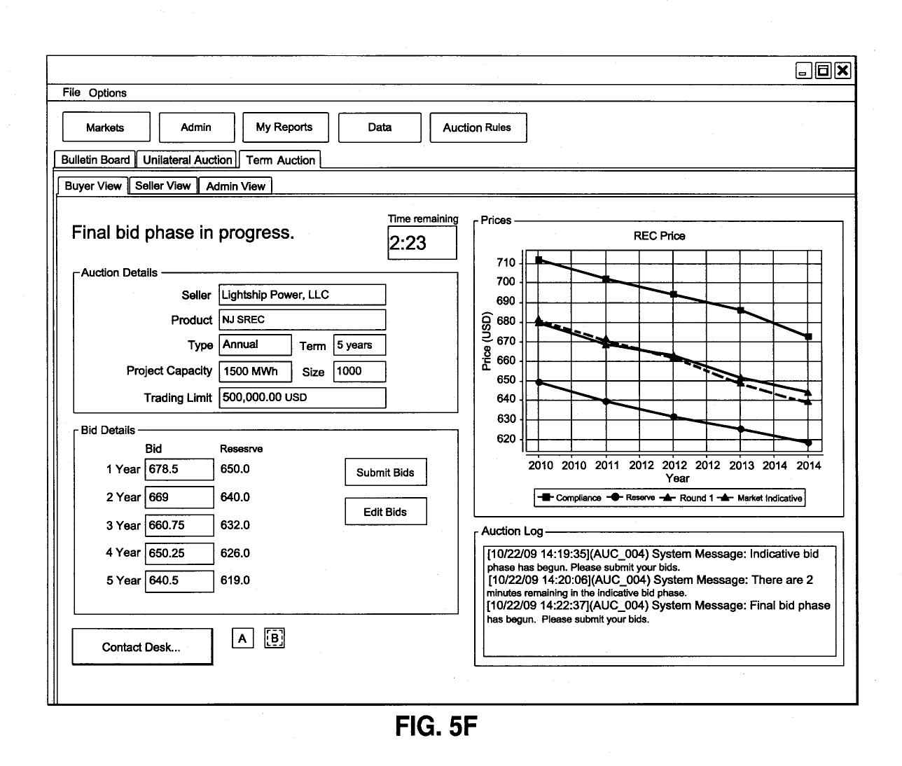

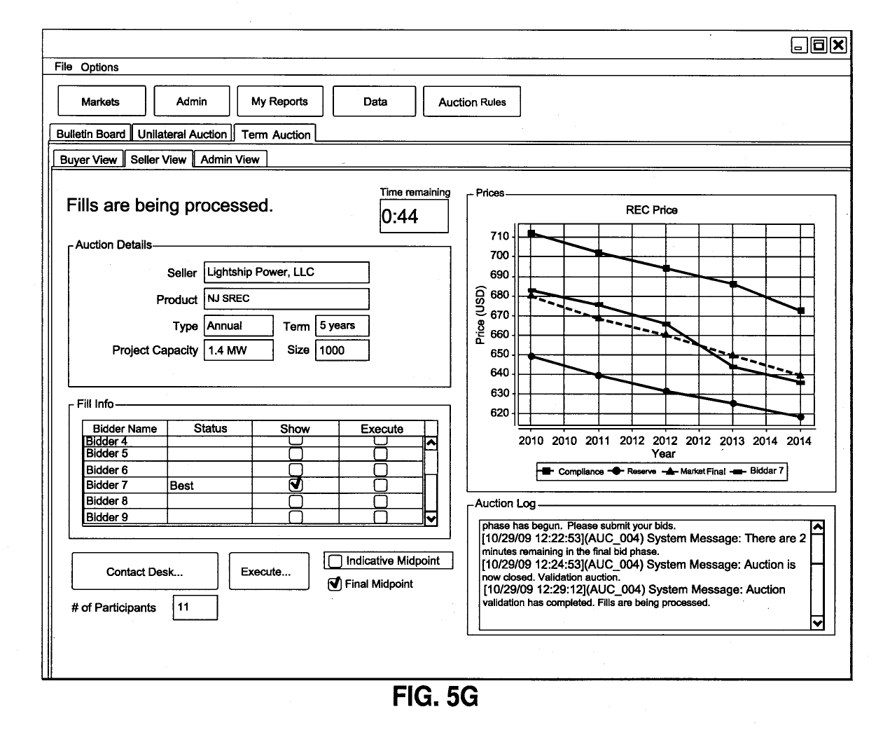

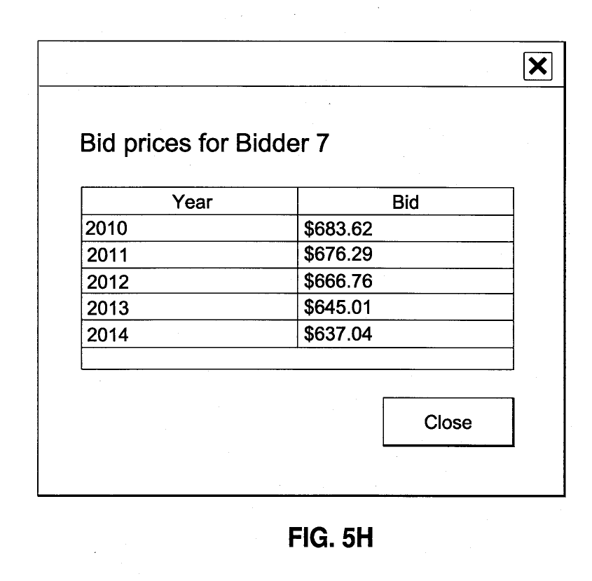

Referring now to FIG. 5A, depicted is another embodiment of the auction module 130 of FIG. 1A. However, in the embodiment of FIG. 5A, the auction module 500 is configured to implement a multi-term unilateral auction of RECs (or any other environmental commodity) in which a single winner is awarded the total quantity to be sold. With the multi-term unilateral auction, there may be two rounds in the process—establishing the market midpoint and identifying the best and final bids—as shown in the embodiment of FIG. 5A. Alternatively, there may be only a single round which does not rely on the publishing of a market midpoint, as shown in FIG. 5B.

In the case of the two-round process of FIG. 5A, once a quorum of bidders is achieved, bidders can begin submitting bids. Sellers will be able to monitor key events in the progress of an auction (see FIG. 5C), while buyers will utilize a bidding screen to submit and edit bids (see FIG. 5D). Bidding continues until the auction time expires. Participants may be given a warning prior to the close of bidding, followed by an alert once the auction is closed to further bidding.

Submitted bids may be validated against a predetermined set of criteria. For example, the price bid for each vintage may be required to be greater than the reserve price as indicated in during auction setup, and may be no greater than the compliance price per vintage plus some percentage (e.g., 25%) as a way to protect bidders against data entry error.

Following the close of the first round, the auction platform may then complete validations to confirm a successful round and calculate a market midpoint curve, which will then be displayed to all participants on their respective auction screens.

During the second round of the embodiment of FIG. 5A, or in the case of the single round embodiment of FIG. 5B, sellers will be able to monitor key auction events via their auction screens (see FIG. 5E), while bidders submit bids via their auction screens (see FIG. 5F). Validation of the price may be performed to ensure that the price bid for each vintage is greater than the reserve price indicated during auction setup, and also not greater than the compliance price per vintage plus some predetermined percentage.

While bidders may submit bids on a fixed-interval basis auction (e.g., yearly), as shown in FIG. 5F, bidders may alternatively be provided with the ability to define the time interval for which a bid should be applied using the concept of ranges. In particular, rather than entering bids for Year 1, Year 2, etc., bids may be entered for Range 1, Range 2, etc, where each range is client defined. By way of example, for a 5 year trade, Range 1 may be defined as inclusive of years 1-3, while Range 2 may include years 4 and 5. The client-defined ranges may be applied to a single round sealed bid or “Final” round of bidding. Additionally, the quantity may be validated at the range level. Other validations at the range level may include minimum valid bids and minimum aggregate amount. Moreover, a single winner may be selected for each range.

Once the bidding is closed, the auction platform may confirm that a successful round has been completed, meaning at a minimum that all submitted bids are valid and a quorum of valid bids is present.

Following auction validation, seller may be presented with the full spectrum of anonymized “Best and Final” bids to select the curve that best suits their business needs, as shown for example in FIG. 5G, with an indication from the system of the best curve based solely on price.

Sellers may also be provided with tools via their auction screens to aid in decision making, such as the ability to turn on and off individual curves on graph, ability to mouse over a specific point on the curve to view the underlying price, ability to view contract term specifics and the ability to view submitted bids as lists of prices (see FIG. 5H). The seller will then be able to select an individual curve as the winner and be prompted to confirm the execution of the fill prior to completion of the order.

Alternately, the platform may support other auctions methodologies, such as the following:
1. Full curve quantity variable: auction where bidders submit prices and quantities for the entire curve being auctioned.
2. Vintage All or nothing: bidders submit prices per vintage desired, where the winning bidder received all RECs for the specified vintage.
3. Vintage/Quantity variable: as described in more detail below, bidders submit prices and quantities for desired vintages, winners will receive full or partial fills per vintage. Quantity groups may be defined at the range level and bid on accordingly, e.g. an auction for 10,000 RECs per vintage, may have a lot size set at 1,000 RECs per year. Bidders may input a price per vintage and a number of lots to be bid on, on a per range basis.
4. Display Rank: Bidders will be shown their rank in the auction through the open bidding phase and will disappear during the 2 minute window prior to auction close.
5. Unit Contingent: Auction of a variable number of RECs for future vintages to be produced from specific projects. The event may or may not occur subsequent to the multi-term auction of a firm amount for the same project.

Additionally, an automated fills methodology may be used in connection with any multi-term auction. In one or more embodiments, the automated fills methodology may include a two-step process in which the first step is bid ranking and the second step is bid filling. In the first step—bid ranking—valid bids in each range may be ranked independently based on a series of predetermined criteria. By way of a non-limiting example, the bid ranking may be based on the following criteria, listed in descending order of consideration:
Total average price of the range;
In the event of a tie for the above criteria, price in first year of Range;
In the event of a tie for the above criteria, price in second year of Range;
In the event of a tie for the above criteria, price in n year of Range;
In the event of a tie for the above criteria, quantity; and
In the event of a tie for the above criteria, time stamp.

In the second step—bid filling—ranked bids may be filled independently for each range. This may be done in descending order until the quantity filled equals the available quantity. In the event that filling the next incremental bid would result in the quantity filled being greater than the available quantity, the final bidder may be filled only partially such that the quantity filled equals the available quantity.

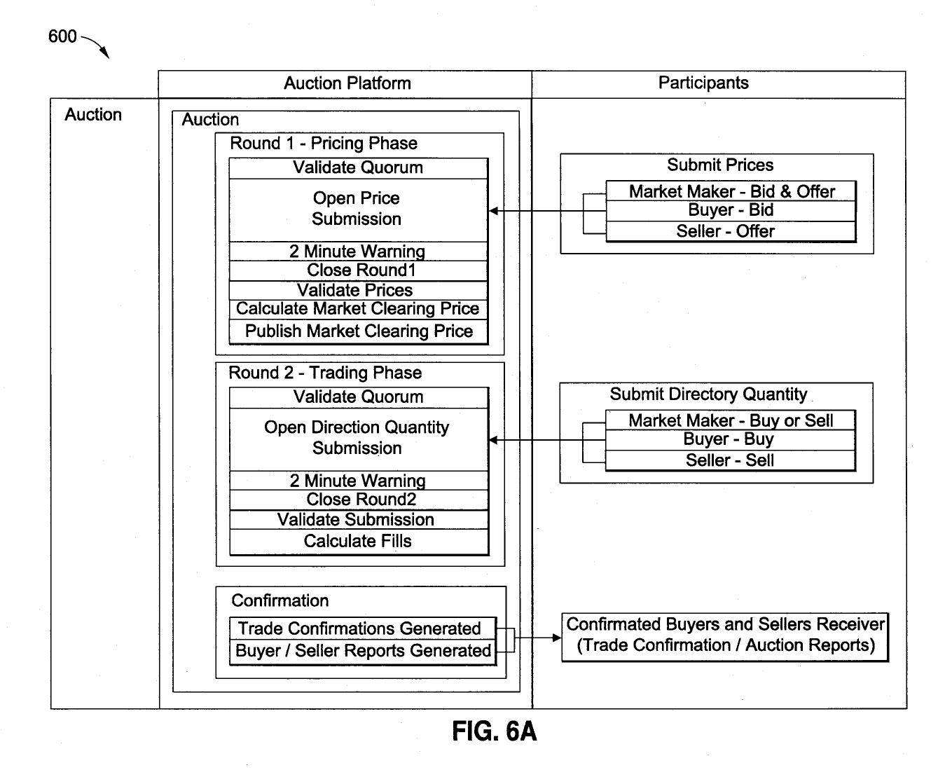

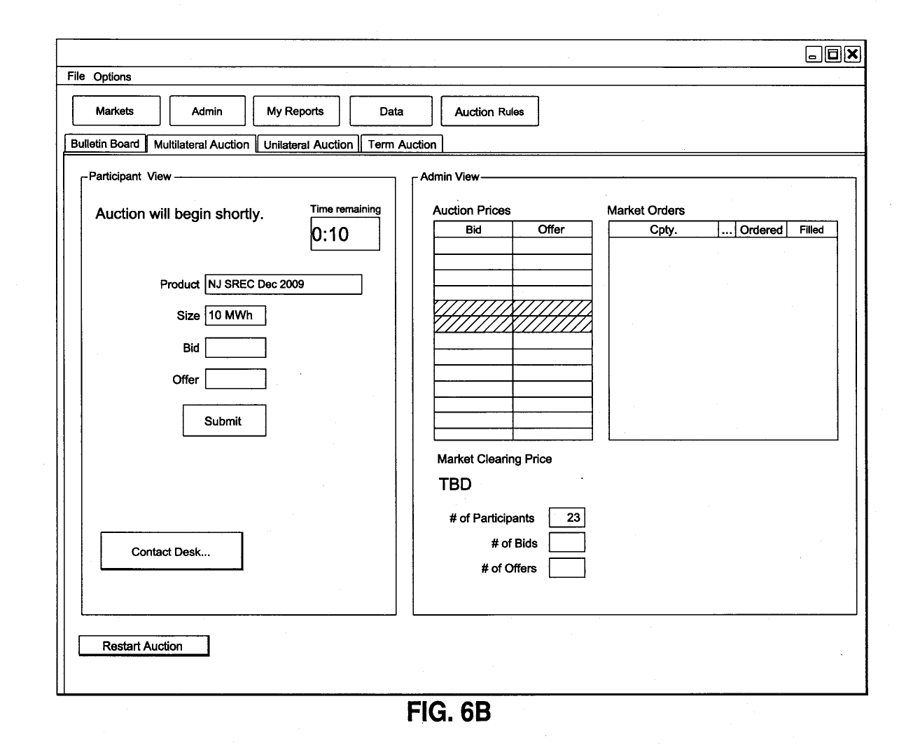

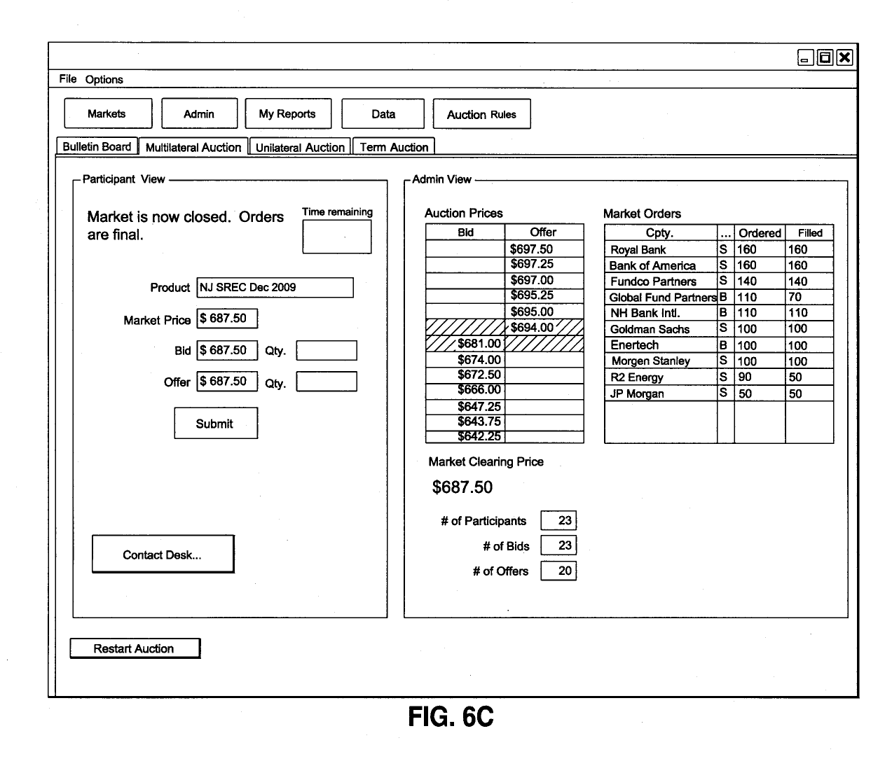

Referring now to FIG. 6A, depicted is another embodiment of the auction module 130 of FIG. 1A. However, in the embodiment of FIG. 6A, the auction module 600 is configured to implement a multilateral auction of RECs (or any other environmental commodity) which consists of two rounds—price submission and trading.

Once a quorum of bidders is achieved, participants may utilize an auction screen to begin submitting bids (see FIG. 6B). Submitted prices may be validated against various criteria set during auction setup, such as participant type (i.e., buyers must submit a bid while sellers must submit an offer) and price (i.e., prices may be required to be greater than X % (e.g., 25%) of the compliance price, while also not being greater than the compliance price plus some additional percentage). Participants may be given a warning prior to the close of bidding, followed by an alert once the auction is closed to further bidding.

Following the close of Round 1, a market clearing price will be determined. In certain embodiments the market clearing price is determined after remove prices that cross, and eliminating prices that are more than X (e.g., 2, 3, etc.) standard deviations from the mean of all submitted prices. Finally, the average of the Y (e.g., 3, 4, etc.) best bids and best offers in both directions is computed as the market clearing price.

Following validation of Round 1, Round 2 will begin with participants utilizing their auction screens to submit the quantity desired at the market clearing price to either buy or sell (see FIG. 6C). Submitted quantities may then be validated against certain criteria, such as participant type (i.e., buyers must submit a bid while sellers must submit an offer) and quantity limits (i.e., validated against existing trade limits). Participants may be given a warning prior to the close of bidding, followed by an alert once the auction is closed to further bidding.

As with the previous auction types, once bidding is closed, the auction platform may confirm that a successful round has been completed, meaning at a minimum that all submitted bids are valid and a quorum of valid bids is present.

Upon auction validation, orders may then be filled on a pro-rata basis in which orders may be sorted by direction and participant ranking during Round 1, which is based on how aggressively the participant bid or offered during the Round 1.

If more than one order exists at a winning participant level, the orders may be filled in the following manner:
If the total quantity of the winning orders at a participant level are less than or equal to the total quantity remaining to be bought or sold, all orders will be fully filled.
If the total quantity of the winning orders at a participant level exceeds the total quantity remaining to be bought or sold, a straight percentage calculation will be applied to the quantities of the orders versus the total quantity to be bought or sold. Each winning order will then be filled pro-rata basis.

Still another aspect of the invention relates to the confirmation/reporting aspects of a completed auction. In particular, following the order filling process, a “trade ticket” may be generated and sent to both the buyer and seller. The trade ticket may include one or more of the identity of the Counterparty, Instrument, Buy/Sell, Quantity, Vintage, Price, and Delivery instructions. Such trade tickets may be sent using email, electronic file, fax, etc.

Additionally, a trade confirmation may be generated by the auction platform and forwarded to buyers and sellers as confirmation. The trade confirmation may include any of the trade details, including for example, trade date, parties identity, type of product (e.g., standard RECs, generation contingent, unit contingent, etc.), amount, vintage, price, delivery date(s), method of transfer (e.g., GIS REC tracking system), compliance with applicable programs, whether regulatorily continuing, etc. In addition, some or all of this information may be similarly forwarded to various necessary third parties (e.g., registries, etc.).

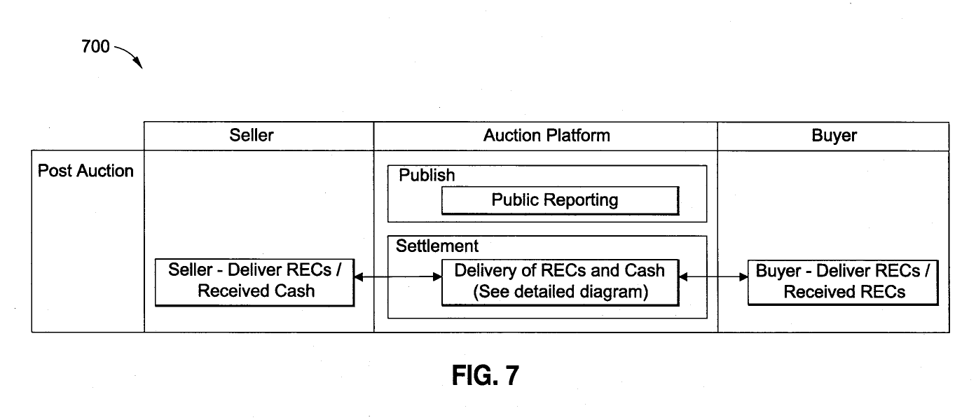

Additionally, part of the confirmation process is to generate and deliver reports specifically intended for active buyers and the seller of RECs. For example, seller reports may include an audit trail of final bids including price per vintage and quantity, number of participants, while buyer reports may include number of participants, percentage of quantity sold and the indicative average price. The aforementioned confirmation/reporting operations may be carried out by a post auction module, such as module 140 of FIG. 1, or the post auction module 700 depicted in FIG. 7.

The post auction module of the present invention (e.g., module 140 of FIG. 1) may also be used to carry out trade settlement operation. In certain embodiments, there may be distinct time frames (single- or multi-term) which follow different paths to completion. The paths to completion may be dependent on the counterparty's credit relationships, i.e., either utilizing trading agreements or financial security.

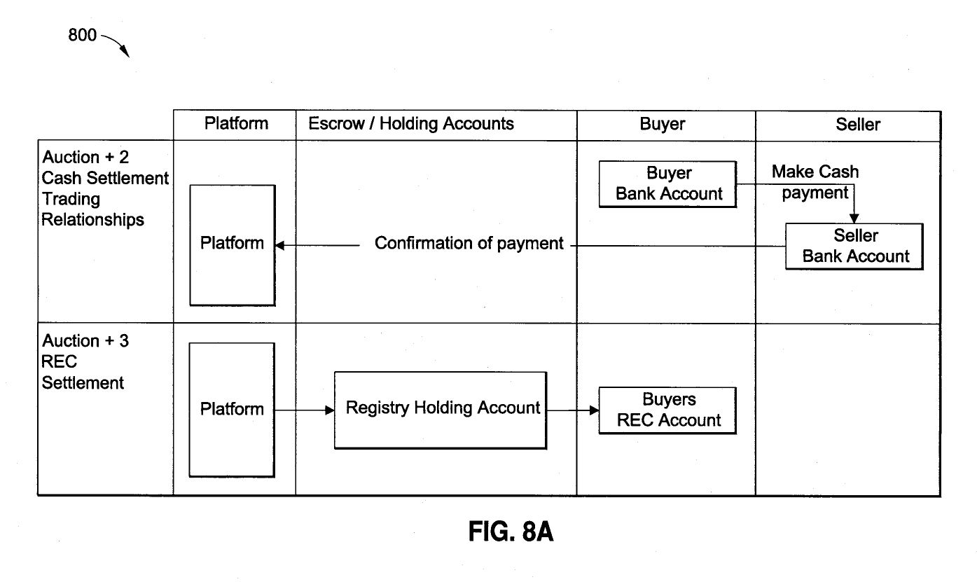

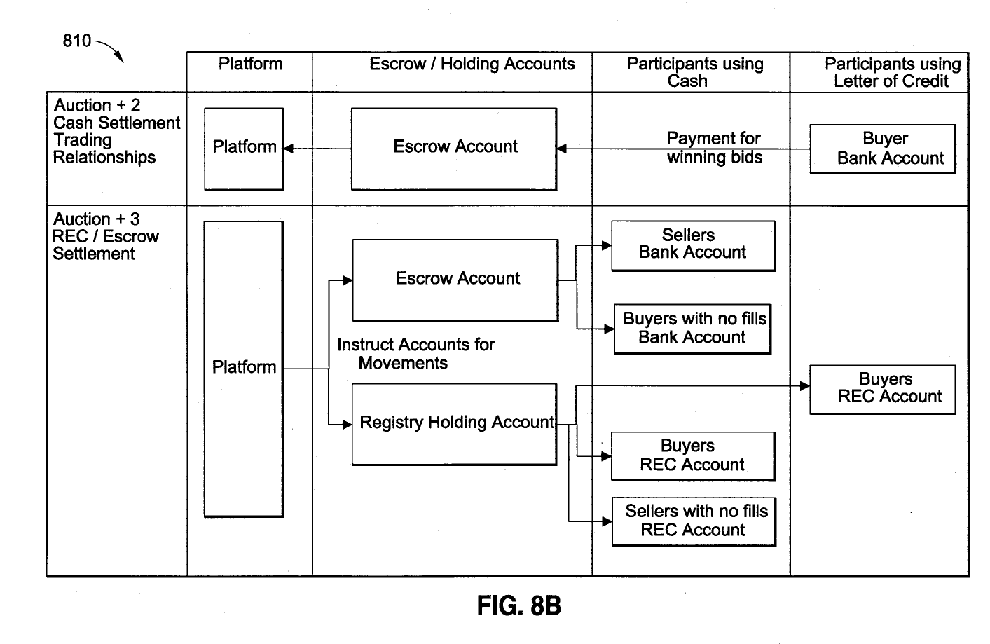

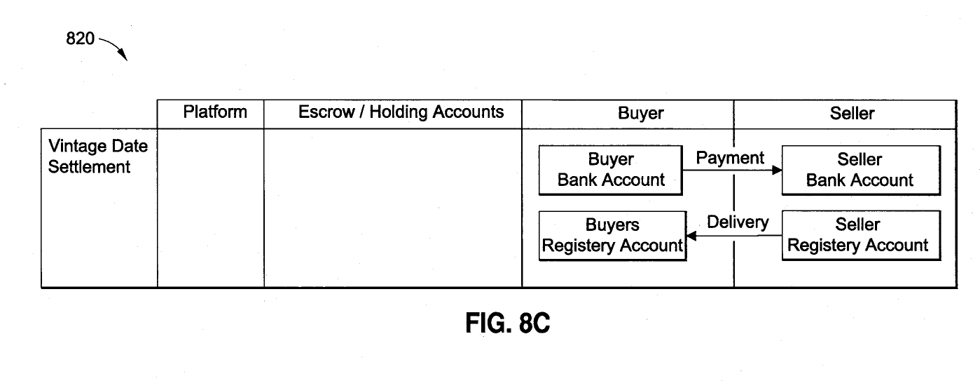

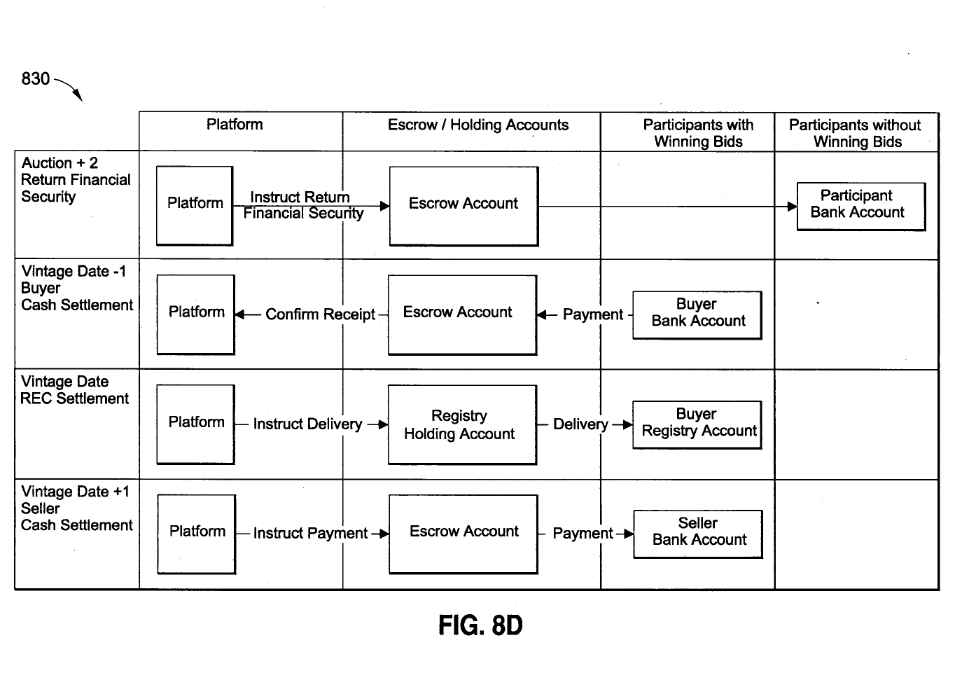

With reference now to FIG. 8A, depicted is one embodiment of a post auction module 800 carrying out spot settlement where the counterparties have a trading agreement relationship. Specifically, two days after the auction day, the buyer is to deliver cash to the seller's account equivalent to the nominal amount of their filled orders. The seller may then confirm receipt of funds. Additionally, three days after the auction day a number of RECs equaling the quantity of filled bids may be delivered to the account(s) of buyer(s). It should of course be appreciated that the day of the cash settlement may be before or after the second day, and that the REC settlement day may be before or after the third day.

Referring now to FIG. 8B, depicted is one embodiment of a post auction module 810 carrying out spot settlement where the counterparties utilizing financial security rather than a preexisting trading agreement. Specifically, two days after the auction day participants (buyers) using Letter of Credit as Financial Security may deliver cash to an escrow account equivalent to the nominal amount of their filled bid and fees. Three days after the auction day financial security may be returned to participants (buyers) without filled bids. Additionally, participants (buyer) with filled bids who have used cash as financial security may receive back their financial security less the nominal amount of any filled bid and fees. Finally, participants (buyers) with filled bids who have used a Letter of Credit as financial security may not receive back funds, but rather a separate payment equaling the nominal amount of the filled bid and fees may be delivered two days after the auction day. It should of course be appreciated that the day of the cash settlement may be before or after the second day, and that the REC settlement day may be before or after the third day.

Referring now to FIG. 8C, depicted is one embodiment of a post auction module 820 carrying out multi-term settlement where the counterparties have a trading agreement in place. Specifically, all deliveries and payments may be made in accordance with the existing trading agreements and will conform to counterparty requirements and obligations. Additionally, on the vintage date the buyer may deliver cash to seller's account in an amount equivalent to the nominal amount of their filled orders for the specific vintage. The seller may then deliver RECs equaling the quantity of the filled order for the specific vintage to the account of the buyer.

Referring now to FIG. 8D, depicted is one embodiment of a post auction module 820 carrying out multi-term settlement where the counterparties utilize financial security rather than a preexisting trading agreement. In this embodiment, vintage transactions may occur on a delivery-versus-payment basis, with each party receiving payment following the completion and confirmation of delivery.

On day two after the auction date, participants without filled bids may have their total financial security returned to their bank accounts per the agreed to settlement instructions. Thereafter, on the day before the vintage date, participants (buyers) with filled bids may delivery payment equaling the nominal amount of the filled bid per vintage to a designated escrow account. Thereafter, on the actual vintage date, a number of RECs equaling the quantity of filled bids per vintage may be delivered to the registry accounts of winning bidders as per settlement instructions. Finally, on the day after the vintage date the equivalent of the nominal amount of all filled bids per vintage less fees may be delivered to the seller's bank account per settlement instructions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for auctioning environmental commodities on a neutral trading platform in an online environment, wherein the neutral trading platform is implemented using an auction platform server coupled to a network, the method comprising the acts of:
executing, by the auction platform server, an on-boarding process for a plurality of auction participants, which includes an auctioner, wherein the plurality of auction participants utilize client-side devices to access the auction platform server over the network, and wherein the on-boarding process includes having the trading platform enter into one of a subscription agreement, brokerage agreement and auction-specific agreement with the plurality of auction participants;
initiating, by the auction platform server in response to a request by the auctioner, an auction event based on an identified block of environmental commodities;
receiving, by the auction platform server over the network, an indication of financial security from at least one of the plurality of auction participants;
receiving, by the auction platform server over the network, a plurality of bids for the identified block of environmental commodities from the plurality of auction participants;
validating, by the auction platform server, said plurality of bids against a predetermined set of criteria, wherein a winning bidder, from the plurality of auction participants, is selected following said validating using one of an automated fills methodology and auctioner-defined parameters; and
performing a settlement function for the auctioner and the winning bidder for the delivery of, and payment for, said identified block of environmental commodities.

2. The method of claim 1, wherein said auction event is one of a single-term unilateral auction, a multi-term unilateral auction, and a multilateral auction.

3. The method of claim 1, wherein the environmental commodities to be auctioned comprise at least one of renewable energy certificates, carbon offsets, carbon allowances, and energy efficiency credits.

4. The method of claim 1, wherein the indication of financial security comprises one of a trading agreement, financial security/collateral posted to an escrow account, and a waiver of the financial security requirement.

5. The method of claim 1, further comprising receiving, as part of said on-boarding process, client information, including client-defined settlement instructions, for each of the plurality of auction participants, and wherein said client information is stored by the auction platform server in client profiles corresponding to the plurality of auction participants.

6. The method of claim 1, further comprising providing a financial reporting service to the auctioner and the winning bidder, wherein the financial reporting service comprises forwarding financial reports, over the network, to individual counterparties.

7. The method of claim 1, further comprising providing a credit monitoring service to the auctioner and the winning bidder, wherein the credit monitoring service comprises monitoring counterparty credit ratings and providing notices upon credit change events.

8. The method of claim 1, wherein validating said plurality of bids against a predetermined set of criteria comprises verifying that each of said plurality of bids is greater than a reserve price set by a seller for the identified block of environmental commodities, and also less than a compliance price for said identified block.

9. The method of claim 1, wherein receiving the plurality of bids for the identified block of environmental commodities comprises receiving the plurality of bids for a plurality of client-defined time ranges corresponding to the identified block of environmental commodities.

10. The method of claim 1, further comprising providing, by the auction platform server over the network, a plurality of bid curves corresponding to the plurality of bids, from which the auctioner may select the winning bidder.

11. The method of claim 1, wherein the auction event is a reverse auction and the auctioner is a buyer.

12. The method of claim 1, further comprising providing, by the auction platform server, post-trading confirmation and reporting services, corresponding to the auction event, for one or more of the plurality of auction participants.

13. The method of claim 1, further comprising providing, by the auction platform server, collateral management services, corresponding to the auction event, for one or more of the plurality of auction participants.

14. An auction platform server configured to implement a neutral trading platform in an online environment, the server comprising:
a network interface configured to connect the server to a network;
a processor electrically coupled to the network interface; and
a memory electrically coupled to the processor, the memory containing processor-executable instructions for implementing the neutral trading platform, wherein the server configured to:
execute an on-boarding process for each of a plurality of auction participants, which includes an auctioner, wherein the plurality of auction participants utilize client-side devices to access the auction platform server over the network, and wherein the on-boarding process includes having the trading platform enter into one of a subscription agreement, brokerage agreement and auction-specific agreement with each of the plurality of auction participants,
initiate an auction event, in response to a request from the auctioner, based on an identified block of environmental commodities,
receive, over the network, an indication of financial security from at least one of the plurality of auction participants,
receive, over the network, a plurality of bids for the identified block of environmental commodities from one or more of the plurality of auction participants,
validate said plurality of bids against a predetermined set of criteria, wherein a winning bidder, from the plurality of auction participants, is selected using one of an automated fills methodology and auctioner-defined parameters, and
perform a settlement function for the auctioner and the winning bidder for the delivery of, and payment for, said identified block of environmental commodities.

15. The auction platform server of claim 14, wherein said auction event is one of a single-term unilateral auction, a multi-term unilateral auction, and a multilateral auction.

16. The auction platform server of claim 14, wherein the environmental commodities to be auctioned comprise at least one of renewable energy certificates, carbon offsets, carbon allowances, and energy efficiency credits.

17. The auction platform server of claim 14, wherein the indication of financial security comprises one of a trading agreement, financial security/collateral posted to an escrow account, and a waiver of the financial security requirement.

18. The auction platform server of claim 14, wherein the server is further configured to receive, as part of said on-boarding process, client information, including client-defined settlement instructions, for each of the plurality of auction participants, and wherein said client information is stored by the auction platform server in client profiles corresponding to the plurality of auction participants.

19. The auction platform server of claim 14, wherein the server is further configured to provide a financial reporting service to the auctioner and the winning bidder, wherein the financial reporting service comprises forwarding financial reports, over the network, to individual counterparties.

20. The auction platform server of claim 14, wherein the server is further configured to provide a credit monitoring service to the auctioner and the winning bidder, wherein the credit monitoring service comprises monitoring counterparty credit ratings and providing notices upon credit change events.

21. The auction platform server of claim 14, wherein the plurality of bids are validated by verifying that each of said plurality of bids is greater than a reserve price set by a seller for the identified block of environmental commodities, and also less than a compliance price for said identified block.

22. The auction platform server of claim 14, wherein the plurality of bids for the identified block of environmental commodities are provided for a plurality of client-defined time ranges corresponding to the identified block of environmental commodities.

23. The auction platform server of claim 14, wherein the server is further configured to provide, over the network, a plurality of bid curves corresponding to the plurality of bids, from which the auctioner may select the winning bidder.

24. The auction platform server of claim 14, wherein the auction event is a reverse auction and the auctioner is a buyer.

25. The auction platform server of claim 14, wherein the server is further configured to provide post-trading confirmation and reporting services, corresponding to the auction event, for one or more of the plurality of auction participants.

26. The auction platform server of claim 14, wherein the server is further configured to provide collateral management services, corresponding to the auction event, for one or more of the plurality of auction participants.

27. A computer program product, comprising:
a processor readable medium having processor executable code embodied therein for auctioning environmental commodities on a neutral trading platform in an online environment, the processor readable medium having:
processor executable program code to execute an on-boarding process for each of a plurality of auction participants, which includes an auctioner, wherein the plurality of auction participants utilize client-side devices to access the auction platform server over the network, and wherein the on-boarding process includes having the trading platform enter into one of a subscription agreement, brokerage agreement and auction-specific agreement with each of the plurality of auction participants,
processor executable program code to initiate an auction event, in response to a request by the auctioner, based on an identified block of environmental commodities,
processor executable program code to receive, over a network connection, an indication of financial security from at least one of the plurality of auction participants,
processor executable program code to receive, over the network connection, a plurality of bids for the identified block of environmental commodities from the plurality of auction participants,
processor executable program code to validate said plurality of bids against a predetermined set of criteria, wherein a winning bidder, from the plurality of auction participants, is selected following said validation using one of an automated fills methodology and auctioner-defined parameters, and
processor executable program code to perform a settlement function for the auctioner and the winning bidder for the delivery of, and payment for, said identified block of environmental commodities.
